(19) United States
(12) Patent Application Publication
(10) Pub. No.: US 2004/0075638 A1
(43) Pub. Date: Apr. 22, 2004

(54) USB based on-line on-screen display and method for switching between microprocessor based electronic devices

(76) Inventor: Hsu Han, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/271,740

(22) Filed: Oct. 17, 2002

(51) Int. Cl. G09G 5/00

(52) U.S. Cl. 345/156

(57) ABSTRACT

A USB-based on-line OSD (on-screen display) system includes at least a USB switching controller, a USB port switch, a display controller and at least one hardware actuator unit and a platform actuator unit. The USB port switch is connected to USB interface ports of at least two computers and is controlled by the USB switching controller to access and switch between the USB interface ports of the computers. The display controller is controlled by the USB switching controller to display the display image of the selected computer. The USB switching controller receives a switching command from the hardware actuator unit and/or the platform actuator unit and issues, in response thereto, a control signal to the display controller to switch the displayed image between the computers. The platform actuator unit that is embodied in the computers and is displayed on the display device provides a dialog box for operator selection between the computers.

### BACKGROUND OF THE INVENTION

1. Field of the Invention

The present invention generally relates to a USB based on-line OSD (On-Screen Display) and the operation method thereof for switching between for example a number of computers with a single common display device.

2. The Related Art

KVM (Keyboard-Video-Mouse) switches are commonly employed to connect a number of computers or operation platforms to a single common keyboard, mouse and/or console (or monitor). The earliest version of the KVM switches includes hardware switches or relays for performing switching of signals between the computers. The mechanical contacts of the KVM switch get aging after long-term operation, leading to degradation of picture displayed. Circuits of amplification and compensation are added in the KVM switch to alleviate picture degradation, yet it does not show to an operator to which computer or platform with operation system the current status displayed picture belongs.

Additional hardware or firmware allows the KVM switch to display switching information on the display screen. However, operator directly access to the displayed image via the computers on the display device is not allowed. In addition, since the hardware or firmware is independent of the operation system of the computers, integrating the displayed switching information with the operation platforms of the computers, such as Microsoft Windows, Macintosh, Linux and Sun Micro, is not allowed. That means the operator cannot directly switch among different computers under these platforms, imposing undesired constrains and troubles to display message maintenance and operation. In addition, the hardware or firmware is costly.

Some of the conventional KVM switches use parallel or serial port interface for data transmission and switching operation. Such an interface is easily subject to constrain of amplification gain and bandwidth of data transmission. Further, such an interface imposes a limitation to the distance between devices to be switched.

Taiwan Patent Publication No. 362778 discloses a device for monitoring computer video signals in a multiplexing manner, comprising a KVM switch comprised of complicated and bulky sized hardware circuits. Besides the high costs it needs to build up the device, the known device does not indicate to the operator to which computer the currently displayed image belongs and cannot be integrated with the operating systems of the computers.

### SUMMARY OF THE INVENTION

Thus, an object of the present invention is to provide a USB-based on-line OSD (On-Screen Display) system comprising a USB switching controller and a display controller to control switching operation among a multiplicity of computers or operation platforms without mechanical switches whereby quality of displayed image is ensured.

Another object of the present invention is to provide a USB-based on-line OSD system comprising a USB switching controller that can be actuated by a hardware-based actuator unit or an operation platform-based actuator unit whereby the USB-based on-line OSD system can be integrated with different hardware-based actuator units and operation platform-based actuator units for display of signal switching.

A further object of the present invention is to provide a USB-based on-line OSD system that is compatible with different operation platforms and is actuateable by the operation platform based actuator unit, the operation platform based actuator unit showing the switching operation picture and signal switching information to allow an operator to access information and data of the computer to which the switching operation picture belongs.

Yet a further object of the present invention is to provide a USB-based on-line OSD system comprising a USB port switch which cooperates with the USB-based switching controller to switch display information among different computers and operation platforms via USB interface ports of the computers and the operation platforms whereby switching of displayed information is not subject to constraints of bandwidth.

To achieve the above objects, in accordance with the present invention, there is provided a USB-based on-line OSD system comprising at least a USB switching controller, a USB port switch, a display controller and at least one hardware actuator unit and a platform actuator unit. The USB port switch is connected to USB interface ports of at least two computers and is controlled by the USB switching controller to access and switch between the USB interface ports of the computers. The display controller is controlled by the USB switching controller to display the display image of the selected computer. The USB switching controller receives a switching command from the hardware actuator unit and/or the platform actuator unit and issues, in response thereto, a control signal to the display controller to switch the displayed image between the computers. The platform actuator unit that is embodied in the computers and is displayed on the display device provides a dialog box for operator selection between the computers. The method for switching between at least two computers with the USB-based on-line on-screen display system comprises the steps of (A) each one of the computers issuing inquiry of latest switching setting information to the USB-based on-line OSD system via the USB interface port thereof, (B) the USB-based on-line OSD system accessing switching status parameters of each one of the computers via the USB interface ports, (C) the USB-based on-line OSD system displaying the switching status of the computers on the display device, (D) one of the hardware actuator unit and the platform actuator unit issuing a command of switching the display images among the computers, and (E) the USB-based on-line OSD system switching the display device to a selected one of the computers and the operation platform.

### BRIEF DESCRIPTION OF THE DRAWINGS

The present invention will be apparent to those skilled in the art by reading the following description of preferred embodiments thereof, with reference to the attached drawings, in which:

FIG. 1 is a block diagram of a USB-based on-line OSD system in accordance with a first embodiment of the present invention;

FIGS. 2A-2D show the operation of a platform actuator unit in accordance with the present invention;

FIG. 3 is a flow chart of the operation of the USB-based on-line OSD system in accordance with the present invention;

FIG. 4 is a flow chart of the switching between computers in accordance with the present invention; and

FIG. 5 is a block diagram of a USB-based on-line OSD system in accordance with a second embodiment of the present invention.

### DETAILED DESCRIPTION OF THE PREFERRED EMBODIMENTS

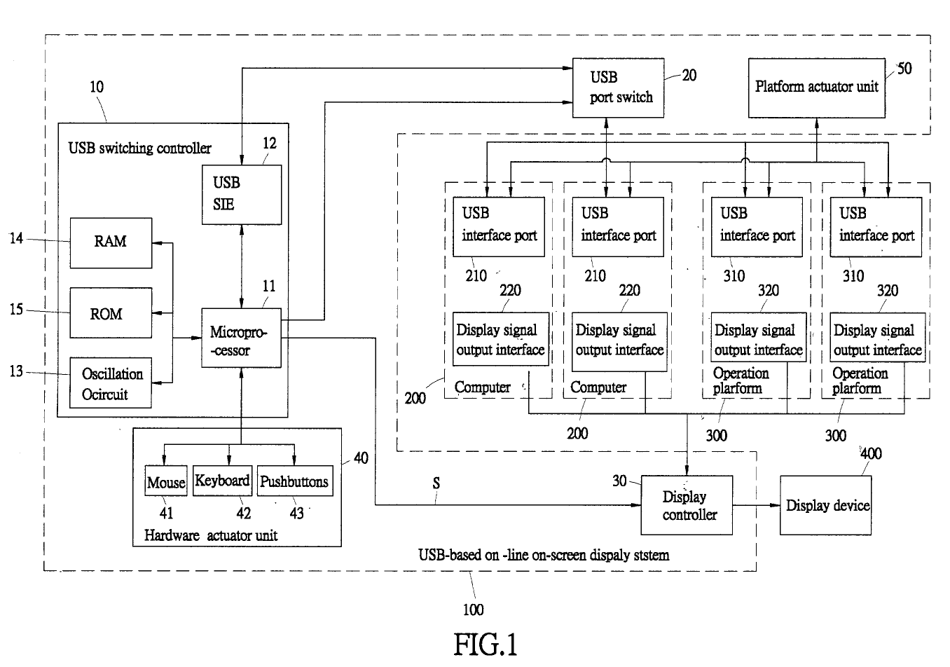

With reference to the drawings and in particular to FIG. 1, a USB-based on-line OSD system constructed in accordance with the present invention, generally designated with reference numeral 100, comprises a USB switching controller 10 connected to a plurality of computers 200 and/or operation platforms 300 via a USB port switch 20. A hardware actuator unit 40 is connected to the USB switching controller 10 to provide a hardware actuation signal to the USB switching controller 10. A platform actuator unit 50 embodied in software form in each of the computers 200 and the operation platforms 300 is selectively coupled to the USB switching controller 10 via the USB port switch 20. The computers 200 and the operation platforms 300 have a common and single display device 400 that is connected to the computers 200 and the operation platforms 300 via a display controller 30. The display controller 30 is also connected to and controlled by the USB switching controller 10 for selectively displaying information from the computers 200 and the operation platforms 300 on the display device 400.

The USB switching controller 10 comprises a microprocessor 11 giving commands to switch display signals between the computers 200 and/or the operation platforms 300, responding to inquiry of switching status and receive the switching actuated signal from the hardware actuator unit 40 and the platform actuator unit 50. The hardware actuator unit 40 is connected to the microprocessor 11 directly for allowing for issuing the switching actuated signal. The USB switching controller 10 comprises a USB serial interface engine (SIE) 12 that connects the USB port switch 20 to the microprocessor 11. The USB port switch 20 is directly controlled by the microprocessor 11. The platform actuator unit 50 that is embodied in software form in the computers 200 and platforms 300 is thus coupled to the microprocessor 11 via the USB port switch 20 and the SIE 12.

An oscillation circuit 13 is coupled to the microprocessor 11 to provide working clock to the microprocessor 11. The microprocessor 11 has a random access memory (RAM) 14 and a read only memory (ROM) 15 for storage of programs of the microprocessor 11, switching parameters of the displayed images and other temporary data.

It is apparent to those having ordinary skills in the arts that the components of the USB switching controller 10 described above are examples only and the present invention is not limited thereby. The USB switching controller 10 can be embodied in equivalent forms, such as ASIC, field programmable gate array, program storage memory, downloadable code storage, custom gate array, programmable logic cell array and erasable programmable logic device.

The hardware actuator unit 40 can be any manually controlled input device, such as a mouse 41, a keyboard 42 and pushbuttons 43. The input device 41, 42, 43 can be operated by an operator to issue a hardware actuation signal to the microprocessor 11 for selecting and switching displayed images among the computers 200 and the operation platforms 300. The selection of display images of the computers 200 and the platforms 300 allows the operator to access the computers 200 and the operation platforms 300 via the input devices 41, 42, 43. Thus, all the computers 200 and the operation platforms 300 share the same mouse 41, the same keyboard 42 and the same pushbuttons 43 which allows the operator to switch among the computers 200 and the operation platforms 300 at the operator side.

The computers 200 and the operation platforms 300 can be any computers and microprocessor based electronic devices, such as personal computers, industry computers, surveillance system, and tablet PC. Each one of the computers 200 and the operation platforms 300 comprises a USB interface port 210, 310 connected to the USB port switch 20. The USB port switch 20 receives the switching command from the USB switching controller 10 in a multiplexing manner and, in response thereto, communicates with and accesses the USB interface ports 210, 310 of all the computers 200 and the operation platforms 300. The USB port switch 20 accesses the switching status of the computers 200 and the operation platforms 300 from the USB interface ports 210, 310 and transmits the switching status to the microprocessor 11 of the USB switching controller 10. The USB port switch 20 also receives and transmits the inquiry of switching status from the computers 200 and the operation platforms 300 to the microprocessor 11.

Each one of the computers 200 and the operation platforms 300 comprises a display signal output interface 220, 320 which is connected to the display controller 30 for supplying display signal from the computers 200 and the operation platforms 300. The display controller 30 receives a display signal switching signal S, which is generated by the microprocessor 11 of the USB switching controller 10, in accordance with the actuation signal of the hardware actuator unit 40 and/or the platform actuator unit 50, from the USB switching controller 10 and switch the display device 400 to a selected one of the computers 200 and the operation platforms 300 according to the signal S received. Thus, the display device 400 shows the display information from the selected computer 200 or operation platform 300.

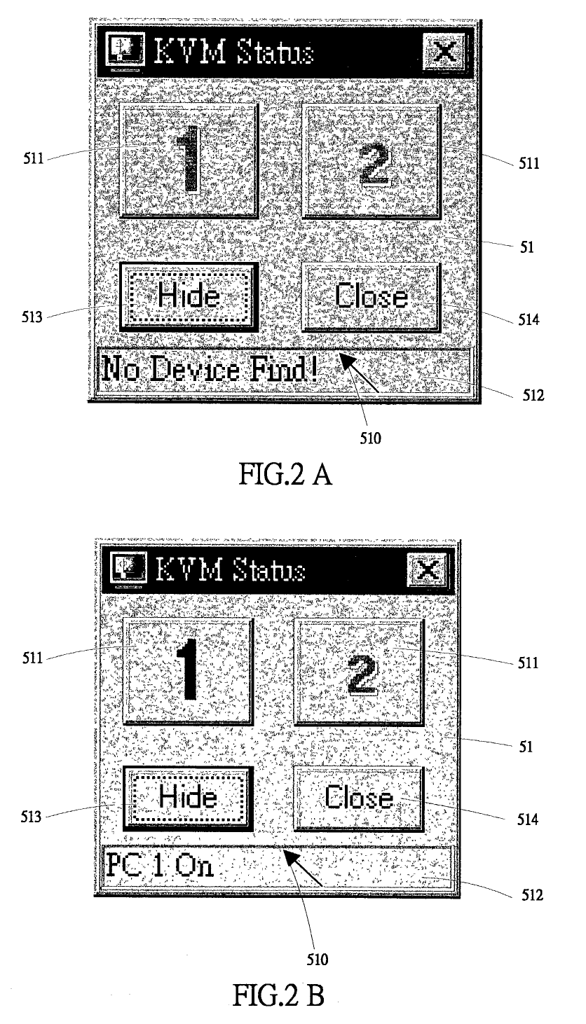

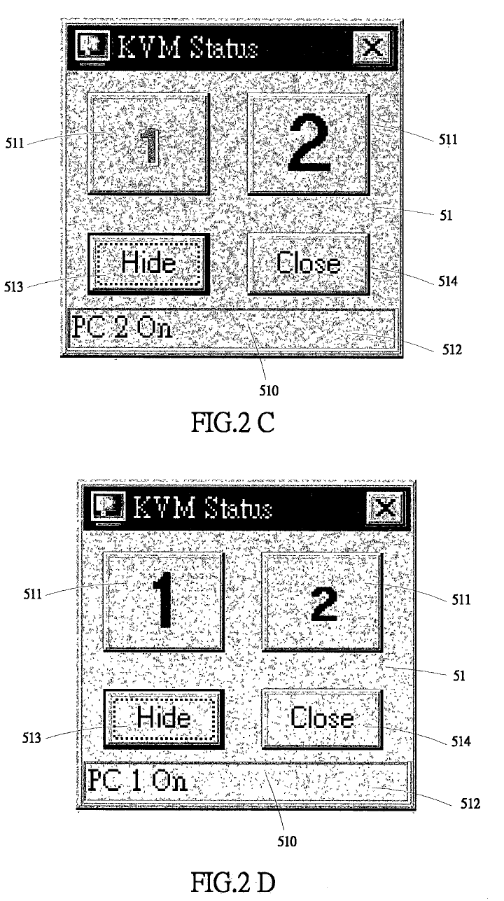

Also referring to FIGS. 2A-2D, which show the images of the platform actuator unit 50 displayed on the display device 400, the platform actuator unit 50 in the embodiment illustrated is embodied in software form in the computers 200 and the operation platforms 300 and compatible with all kinds of operation systems and platform software, such as Windows of Microsoft, Macintosh of Apple, Linux and Sun Micro whereby the platform actuator unit 50 is executable in these operation systems and platforms to issue switching commands and inquiry of switching status to the USB switching controller 10. In the embodiment illustrated, the platform actuator unit 50 is displayed in a dialog box 51 having a plurality of switching buttons 511 for user selection of microprocessor based devices (the computers 200 and the operation platforms 300) to be displayed, a switching status bar 512 indicating which microprocessor based device 200, 300 is displayed, a “hide” button 513 and a “close” button 514 for allowing the operator to use the mouse 41 to control a cursor 510 for operating the platform actuator unit 50. It is apparent that the above description of the platform actuator unit 50 is illustrative only and the present invention is not limited thereto.

It is apparent to those having ordinary skills that the hardware actuator unit 40 and the platform actuator unit 50 are not necessary to be present in the system simultaneously or be used at the same time. Either one of the actuator units 40, 50 can be used to control the system and control the operation of the computers 200 and the operation platforms 300.

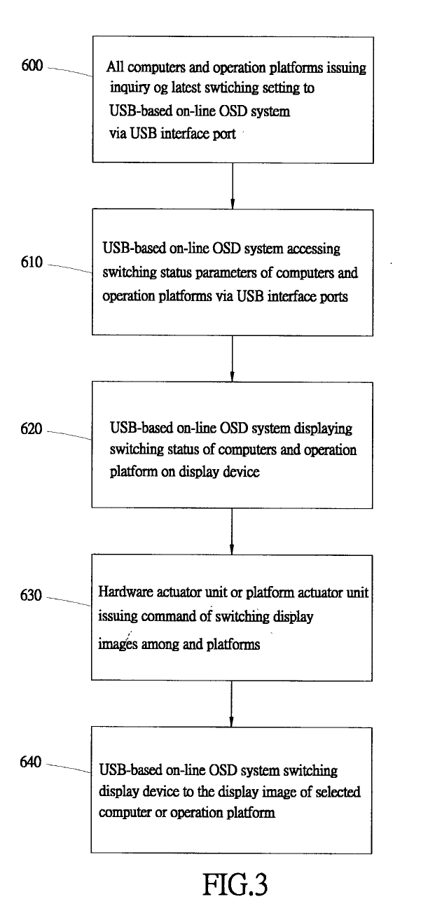

With reference to FIG. 3, a flow chart of switching among a plurality of computers 200 and/or platforms 300 with the USB-based on-line OSD system 100 of the present invention is shown. The method includes the following steps:

Step 600: All the computers 200 and the operation platforms 300 issue inquiry of the latest switching setting information to the USB-based on-line OSD system 100 via the USB interface port 210, 310 thereof.

Step 610: The USB-based on-line OSD system 100 accesses switching status parameter of each computer 200 and operation platform 300 via the USB interface port 210, 310 of the computer 200 and the operation platform 300.

Step 620: The USB-based on-line OSD system 100 displays the switching status of the computers 200 and the operation platforms 300 on the display device 400.

Step 630: The hardware actuator unit 40 or the platform actuator unit 50 issues a command of switching the display images among the computers 200 and the platforms 300.

Step 640: The USB-based on-line OSD system 100 switches the display device 400 to the display image of the selected computer 200 or operation platform 300.

It can be understood from the above operation process that the USB-based on-line OSD system 100 is performing the switching operation among the computers 200 and the operation platforms 300 via the USB interface of the computers 200 and the operation platforms 300.

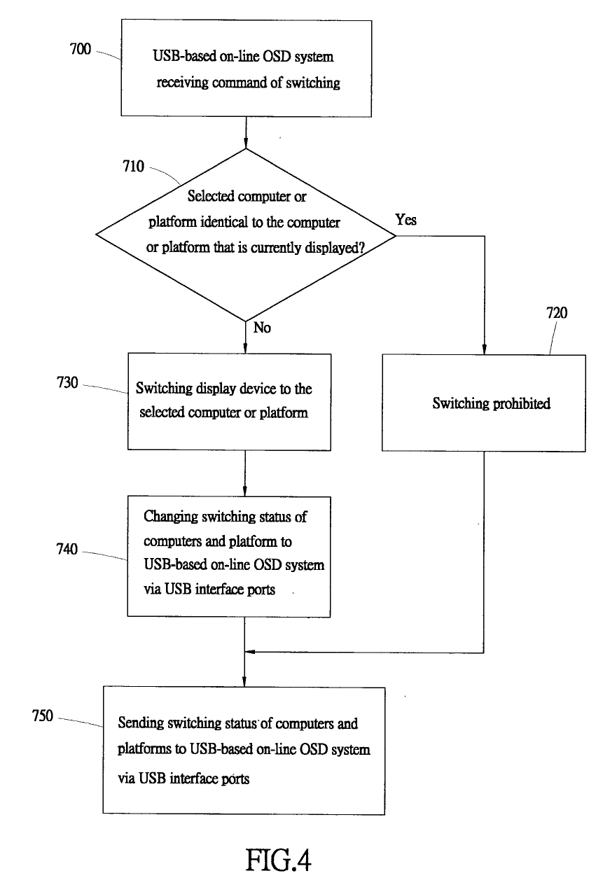

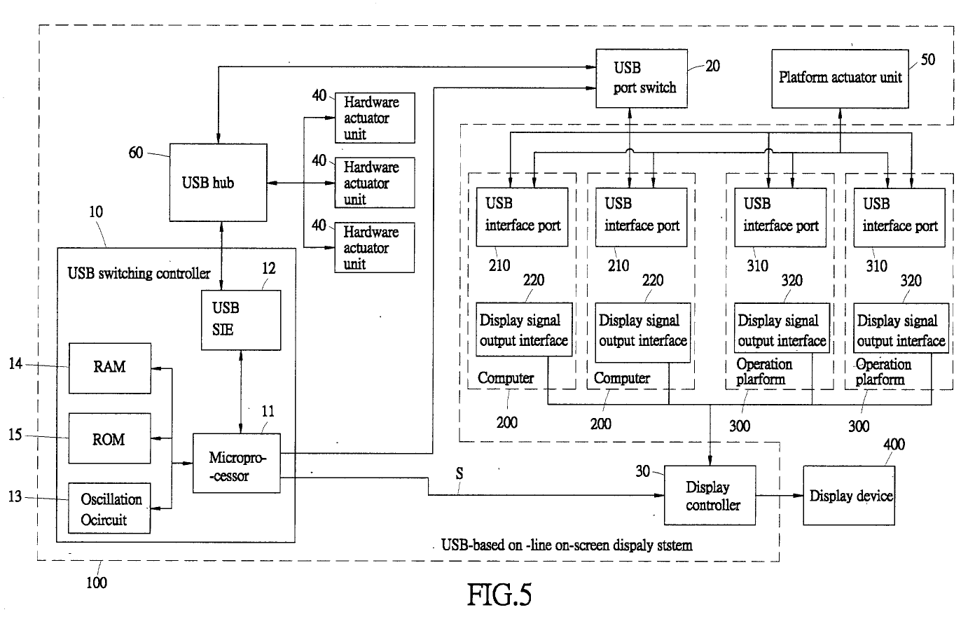

FIG. 4 shows a flow chart of switching the display device 400 to the display image of the selected computer 200 or operation platform 300 by the USB-based on-line OSD system 100 of the present invention. The process includes the following steps:

Step 700: The USB-based on-line OSD system 100 receives the command of switching from the hardware actuator unit 40 or the platform actuator unit 50.

Step 710: The USB-based on-line OSD system 100 determines if the selected computer 200 or platform 300 is identical to the computer 200 or platform 300 that is currently displayed. If the determination is positive, the process goes to step 720, otherwise the process goes to step 730.

Step 720: The USB-based on-line OSD system 100 responds to the command of switching by indicating that the switching is prohibited.

Step 730: The USB-based on-line OSD system 100 switches the display device 400 to the selected computer 200 or platform 300.

Step 740: The USB-based on-line OSD system 100 changes the switching status parameters of the selected computer 200 or platform 300 that is switched to the display device 400.

Step 750: The computers 200 and operation platforms 300 send the switching status thereof to the USB-based on-line OSD system 100 via the USB interface port thereof.

FIG. 5 shows another embodiment of the USB-based on-line OSD system in accordance with the present invention, also designated with reference numeral 100 for simplicity. The USB-based on-line OSD system 100 comprises a USB switching controller 10 comprising a microprocessor 11 having a USB serial interface engine (SIE) 12 and a RAM 14, a ROM 15 and an oscillation circuit 13. A number of hardware actuator units 40 are connected to the USB switching controller 10 via a USB hub 60. The USB SIE 12 is connected to USB interface ports 210, 310 of a plurality of computers 200 and platforms 300 via a USB port switch 20. A platform actuator unit 50 embodied in the form of software is installed in the computers 200 and the operation platforms 300 and in communication with the USB switching controller 10 via the USB interface ports 210, 310 and the USB port switch 20. The computers 200 and the operation platforms 300 have display signal output interfaces 220, 320 connected to a display device 400 via a display controller 30 which is controlled by a display signal switching signal S of the microprocessor 11.

The USB hub 60 allows a number of hardware actuator units 40, each selectively including a mouse and a keyboard to be interchangeably connected to computers 200 and the operation platforms 300 via the USB switching controller 10 whereby each computer 200 or operation platform 300 can be controlled or accessed by a number of mice and/or keyboards and each mouse and keyboard can selectively control all the computers 200 and the operation platforms 300.

The present invention provides a system and the method thereof that makes use of the USB interface to establish communication ports between computers and/or operation platforms and a microprocessor based switching controller for KVM type multiplexing switching operation among the computers and/or platforms. Also, the present invention allows the switching system to be actuated by both external hardware based actuator devices or internally established software based actuator devices. The present invention also allows the operators to control the software based actuator devices directly from the displayed image.

Although the present invention has been described with reference to the preferred embodiment thereof, it is apparent to those skilled in the art that a variety of modifications and changes may be made without departing from the scope of the present invention which is intended to be defined by the appended claims.

What is claimed is

1. A USB-based on-line OSD system for switching display images between at least two computers and operation platforms having USB interface, the system comprising:
a USB switching controller which selectively issues a switching command and receives and executes inquiry of switching status from the computers and the operation platforms;
a USB port switch connected between the USB switching controller and the USB interfaces of the computers and the operation platforms and controlled by the USB switching controller to obtain switching status, inquiry of switching status and switch status parameters of the computers and the operation platforms from the USB interface of the computers and the operation platforms and transmit the obtained information to the USB switching controller;
a display controller connected to the display signal output interfaces of the computers and the operation platforms to receive display signals from the computers and the operation platforms and controlled by a switching signal issued by the USB switching controller to switch a single display device to one of the computers and the operation platforms that is selected by the switching signal; and
at least one hardware actuator unit coupled to the USB switching controller to issue a signal for selecting the one of the computers and the operation platforms to the USB switching controller whereby the USB switching controller issues the switching signal to the display controller for switching the display device to the selected one of the computers and the operation platforms.

2. The system as claimed in claim 1, wherein the USB switching controller further comprises:
a microprocessor receiving a switching actuated signal from the hardware actuator unit and issuing the switching signal to the display controller;
a USB serial interface engine connected between the microprocessor and the USB port switch for transmitting the switching status parameters and the inquiry of switching status from the computers and the operation platforms to the microprocessor;
an oscillation circuit for providing a working clock to the microprocessor; and
memory means for storage of programs of the microprocessor and other data.

3. The system as claimed in claim 1, wherein the USB switching controller is a single integrated circuit.

4. The system as claimed in claim 3, wherein the single integrated circuit is an ASIC.

5. The system as claimed in claim 3, wherein the single integrated circuit is a field programmable gate array device.

6. The system as claimed in claim 3, wherein the single integrated circuit is a program storage memory.

7. The system as claimed in claim 3, wherein the single integrated circuit is a downloadable code storage device.

8. The system as claimed in claim 3, wherein the single integrated circuit is a custom gate array device.

9. The system as claimed in claim 3, wherein the single integrated circuit is a programmable logic cell array device.

10. The system as claimed in claim 3, wherein the single integrated circuit is an erasable programmable logic device.

11. The system as claimed in claim 1, wherein the at least one hardware actuator unit is connected to the USB switching controller by a USB hub.

12. The system as claimed in claim 1, wherein the hardware actuator unit comprises a mouse.

13. The system as claimed in claim 1, wherein the hardware actuator unit comprises a keyboard.

14. The system as claimed in claim 1, wherein the hardware actuator unit comprises pushbuttons.

15. A USB-based on-line OSD system for switching display images between at least two computers and operation platforms having USB interface, the system comprising:
a USB switching controller which selectively issues a switching command and receives and executes inquiry of switching status from the computers and the operation platforms;
a USB port switch connected between the USB switching controller and the USB interfaces of the computers and the operation platforms and controlled by the USB switching controller to obtain switching status, inquiry of switching status and switching status parameters of the computers and the operation platforms from the USB interfaces of the computers and the operation platforms and transmit the obtained information to the USB switching controller;
a display controller connected to the display signal output interfaces of the computers and the operation platforms to receive display signals from the computers and the operation platforms and controlled by a switching signal issued by the USB switching controller to switch a single display device to one of the computers and the operation platforms that is selected by the switching signal; and
at least one platform actuator unit installed in the computers and the operation platforms and coupled to the USB switching controller via the USB port switch to issue a signal for selecting the one of the computers and the operation platforms to the USB switching controller whereby the USB switching controller issues the switching signal to the display controller for switching the display device to the selected one of the computers and the operation platforms.

16. The system as claimed in claim 15, wherein the USB switching controller further comprises:
a microprocessor receiving a switching actuated signal from the hardware actuator unit and issuing the switching signal to the display controller;
a USB serial interface engine connected between the microprocessor and the USB port switch for transmitting the switching status parameters and the inquiry of switching status from the computers and the operation platforms to the microprocessor;
an oscillation circuit for providing a working clock to the microprocessor; and
memory means for storage of programs of the microprocessor and other data.

17. The system as claimed in claim 15, wherein the USB switching controller is a single integrated circuit.

18. The system as claimed in claim 17, wherein the single integrated circuit is an ASIC.

19. The system as claimed in claim 17, wherein the single integrated circuit is a field programmable gate array device.

20. The system as claimed in claim 17, wherein the single integrated circuit is a program storage memory.

21. The system as claimed in claim 17, wherein the single integrated circuit is a downloadable code storage device.

22. The system as claimed in claim 17, wherein the single integrated circuit is a custom gate array device.

23. The system as claimed in claim 17, wherein the single integrated circuit is a programmable logic cell array device.

24. The system as claimed in claim 17, wherein the single integrated circuit is an erasable programmable logic device.

25. The system as claimed in claim 15, wherein the platform actuator unit comprises a dialog box displayed on the display device.

26. The system as claimed in claim 25, wherein the dialog box comprises switching buttons, switching status bar, a hide button and a close button.

27. A method for switching display images of at least two computers and operation platforms having USB interface on a single display device by means of a USB-based on-line OSD system comprising at least a hardware actuator unit and a platform actuator unit embodied in the computers and the operation platforms, the method comprising the following steps:
(A) each one of the computers and the operation platforms issuing inquiry of latest switching setting information to the USB-based on-line OSD system via the USB interface thereof;
(B) the USB-based on-line OSD system accessing switching status parameters of each one of the computers and operation platforms via the USB interface of the computers and the operation platforms;
(C) the USB-based on-line OSD system displaying the switching status of the computers and the operation platforms on the display device;
(D) one of the hardware actuator unit and the platform actuator unit issuing a command of switching the display images among the computers and the platforms; and
(E) the USB-based on-line OSD system switching the display device to a selected one of the computers and the operation platform.

28. The method as claimed in claim 27, wherein the hardware actuator unit of step (D) comprises a mouse.

29. The method as claimed in claim 27, wherein the hardware actuator unit of step (D) comprises a keyboard.

30. The method as claimed in claim 27, wherein the hardware actuator unit of step (D) comprises pushbuttons.

31. The method as claimed in claim 27, wherein the platform actuator unit of step (D) comprises a dialog box shown on the display device.

32. The method as claimed in claim 31, wherein the dialog box comprises switching buttons, switching status bar, a hide button and a close button.
